(19) United States
(12) Patent Application Publication
(10) Pub. No.: US 2015/0097745 A1
(43) Pub. Date: Apr. 9, 2015

(54) MOBILE COMMUNICATION DEVICE

(71) Applicant: Acer Incorporated, New Taipei City (TW)

(72) Inventors: Hsin-Hui Chou, New Taipei City (TW); Chih-Hua Chang, New Taipei City (TW)

(73) Assignee: Acer Incorporated, New Taipei City (TW)

(21) Appl. No.: 14/106,872

(22) Filed: Dec. 16, 2013

(30) Foreign Application Priority Data
Oct. 3, 2013 (TW) 102135888

(51) Int. Cl. H01Q 13/10; H01Q 5/00

(52) U.S. Cl. CPC H01Q 13/10; H01Q 5/0093; H01Q 5/0041
USPC 343/767

(57) ABSTRACT

A mobile communication device is provided and includes a ground element and a feeding structure. The ground element includes a slot. The feeding structure crosses the slot and includes a first transmission line, a second transmission line and a resonant circuit. The resonant circuit is electrically connected in series between the first transmission line and the second transmission line. Besides, the resonant circuit receives a feeding signal through the first transmission line and is electrically connected to the ground element through the second transmission line.

### CROSS-REFERENCE TO RELATED APPLICATION

This application claims the priority benefit of Taiwan application serial no. 102135888, filed on Oct. 3, 2013. The entirety of the above-mentioned patent application is hereby incorporated by reference herein and made a part of this specification.

### BACKGROUND OF THE INVENTION

1. Field of the Invention

The present invention generally relates to a mobile communication device, and in particular, to a mobile communication device with a multi-band slot antenna.

2. Description of Related Art

With the rapid development of wireless communication technology, various types of mobile communication devices have been continuously launched and upgraded, and the functions of the mobile communication devices also become more and more diversified. Furthermore, in consideration of the requirements on uniqueness of the appearance, most of the existing mobile communication devices emphasize the thickness of the device. For example, the thickness of the conventional high-level Smartphone should be less than 8 mm. As the mobile communication device becomes thinner, the radiation characteristics of the antennas are apt to be affected so as to reduce the communication performance of the mobile communication device. Therefore, it brings a great challenge to antenna design of the mobile communication device.

In order to overcome the problem of limited space, the conventional mobile communication device employs a slot antenna and disposes the antenna on a printed circuit board. However, in the condition of one slot, most of the conventional slot antennas are incapable of achieving the multi-band operation. Furthermore, because the conventional multi-band slot antenna has a number of slots and the circuit elements and the layout lines in the mobile communication device must be routed away from the number of slots in the antenna, the conventional mobile communication device requires larger areas on the printed circuit board to dispose the multi-band slot antenna, and therefore limit the development of the slim-type mobile communication device.

### SUMMARY OF THE INVENTION

The present invention provides a mobile communication device that disposes a resonant circuit in a feeding structure and employs the feeding structure and a ground element with a slot to form a multi-band slot antenna, so as to facilitate the development of the slim-type mobile communication device.

The mobile communication device of the the invention includes a ground element and a feeding structure. The ground element comprises a slot. The feeding structure crosses the slot and comprises a first transmission line, a second transmission line and a resonant circuit. The resonant circuit is electrically connected in series between the first transmission line and the second transmission line. Furthermore, the resonant circuit receives a feeding signal through the first transmission line and is electrically connected to the ground element through the second transmission line.

Based on the above, the present invention disposes a slot on the ground element and disposes a resonant circuit in the feeding structure. Accordingly, the feeding structure and the ground element with the slot can form a multi-band slot antenna, so as to facilitate the development of the slim-type mobile communication device.

In order to make the aforementioned and other features and advantages of the present invention more comprehensible, several embodiments accompanied with figures are described in detail below.

### BRIEF DESCRIPTION OF THE DRAWINGS

FIG. 1 is a structure diagram illustrating a mobile communication device according to an embodiment of the present invention.

FIG. 2 is a plane diagram illustrating a mobile communication device according to an embodiment of the present invention.

FIG. 3 is a circuit diagram illustrating a resonant circuit according to an embodiment of the present invention.

FIG. 4 is a circuit diagram illustrating a resonant circuit according to another embodiment of the present invention.

FIGS. 5 and 6 are diagrams of return loss and antenna efficiency of the multi-band slot antenna according to an embodiment of the present invention.

### DESCRIPTION OF THE EMBODIMENTS

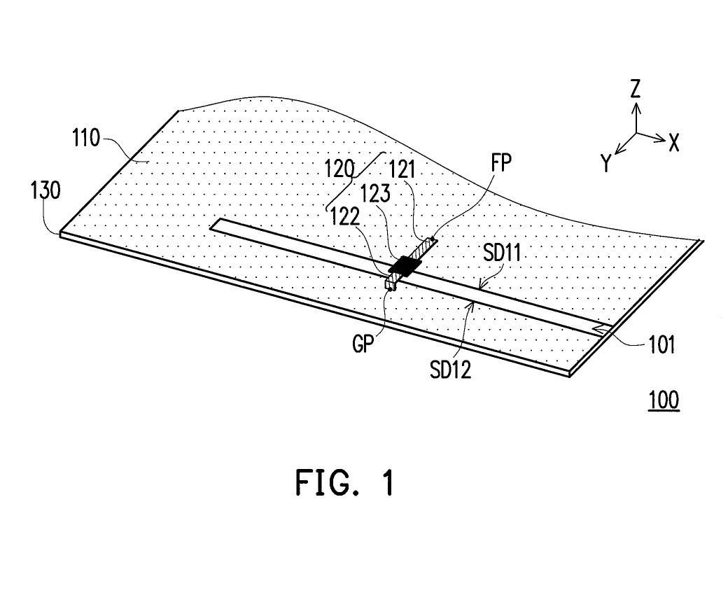

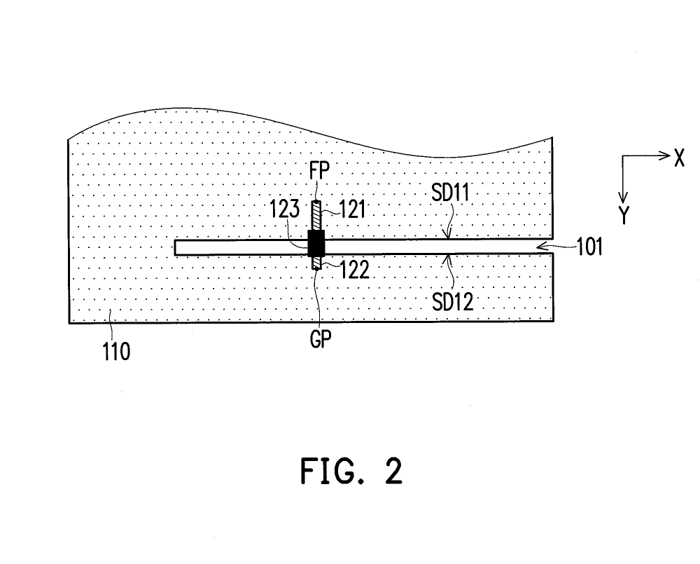

FIG. 1 is a structure diagram illustrating a mobile communication device according to an embodiment of the present invention, and FIG. 2 is a plane diagram illustrating a mobile communication device according to an embodiment of the present invention. Referring to FIG. 1 and FIG. 2, the mobile communication device 100 comprises a ground element 110, a feeding structure 120 and a substrate 130, and the mobile communication device 100 is an electronic device with a wireless transmission function, for example, Smart phone, tablet PC or notebook . . . etc. Wherein, the ground element 110 comprises a slot 101, and the ground element 110 is disposed on the first surface of the substrate 130. Furthermore, the slot 101 penetrates the ground element 110 to expose the first surface of the substrate 130.

The feeding structure 120 crosses the slot 101. For example, the slot 101 in FIGS. 1 and 2 is extended along the direction of X-axis, and the feeding structure 120 is disposed along the direction of Y-axis. In other words, the feeding structure 120 is disposed along an extending direction perpendicular to the slot 101 so as to cross the slot 101. Furthermore, the slot 101 has a closed end and an open end, and the slot 101 comprises two opposite side walls SD11 and SD12. The feeding structure 120 crosses the opposite side walls SD11 and SD12. Also, a shape of the slot 101 is, for example, a line shape, but the present invention is not limited thereto. For example, those skilled in the art may change the shape of the slot 101 as in an L shape or any other irregular geometric shape based on the design requirement.

Furthermore, the feeding structure 120 comprises a first transmission line 121, a second transmission line 122 and a resonant circuit 123. Wherein, the resonant circuit 123 is electrically connected in series between the first transmission line 121 and the second transmission line 122. Specifically, a first end of the first transmission line 121 has a feeding point FP, and a second end of the second transmission line 122 is electrically connected to the resonant circuit 123. In other words, the resonant circuit 123 receives a feeding signal through the first transmission line 121. Furthermore, a first end of the second transmission line 122 is electrically connected to resonant circuit 123, and a second end of the second transmission line 122 has a ground point GP. In other words, the resonant circuit 123 is electrically connected to the ground element 110 through the second transmission line 122.

In an embodiment, the resonant circuit 123 and the second transmission line 122 in the feeding structure 120 are located in the slot 101 and are disposed on the first surface of the substrate 130 with the ground element 110. Furthermore, the first transmission line 121 is composed of a coaxial cable. In another embodiment, the feeding structure 120 is, for example, floated above the ground element 110, and one of the resonant circuit 123, the first transmission line 121 and the second transmission line 122 is opposite to the slot 101 of the ground element 110. Furthermore, the second end of the second transmission line 122 is electrically connected to the ground element 110 through a via so as to form the ground point GP.

In operation, the ground element 110 and the feeding structure 120 form a multi-band slot antenna. Wherein, the multi-band slot antenna generates an excitation mode through the slot 101 to operate in a first band (for example, LTE Band20/GSM850/900). Wherein, a length of the slot 101 is one-eighth wavelength of a lowest frequency of the first band. Furthermore, the resonant circuit 123 in the feeding structure 120 excites the multi-band slot antenna. Accordingly, the multi-band slot antenna can generate another excitation mode through the resonant circuit 123, and therefore operates in the second band (for example, GSM1800/1900/WCDMA Band1). In other words, the multi-band slot antenna only needs to employ one slot 101 to achieve the characteristic of multi-band operation in the present embodiment.

It should be mentioned that, compared with the conventional monopole antenna, loop antenna or planar inverted F antenna (PIFA), the slot antenna requires smaller antenna clearance area and has lower height. Besides, the multi-band slot antenna only needs to employ one slot to achieve the characteristics of multi-band operation in the embodiment. Therefore, the multi-band slot antenna in the present embodiment can reduce the size of the substrate 130, and that further facilitates the development of the slim-type mobile communication device 100.

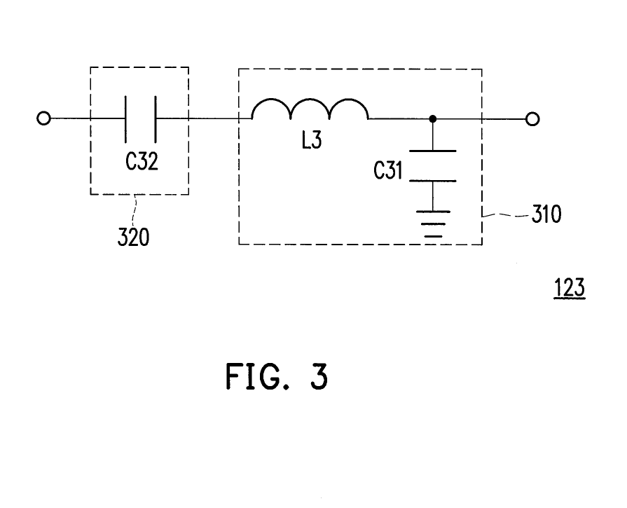

FIG. 3 is a circuit diagram illustrating a resonant circuit according to an embodiment of the present invention. As shown in FIG. 3, the resonant circuit 123 comprises a first resonant unit 310 and a second resonant unit 320. Besides, the first resonant unit 310 comprises a first capacitor C31 and an inductor L3, and the second resonant unit 320 comprises a second capacitor C32. Specifically, a first end of the first capacitor C31 is electrically connected to the first transmission line 121, and a second end of the first capacitor C31 is electrically connected to the ground element 110. A first end of the inductor L3 is electrically connected to the first end of the first capacitor C31, and a second end of the inductor L3 is electrically connected to the second resonant unit 320. A first end of the second capacitor C32 is electrically connected to the second end of the inductor L3, and a second end of the second capacitor C32 is electrically connected to the second transmission line 122.

The first resonant unit 310 generates resonance by the first capacitor C31 and the inductor L3, and a resonance frequency of the first resonant unit 310 is locate in the second band. Namely, the first resonant unit 310 can generate resonance in the second band. Accordingly, under the excitation of the first resonant unit 310, the multi-band slot antenna will operate in the second band. Furthermore, the second capacitor C32 in the second resonant unit 320 is configured to adjust the excitation mode of the multi-band slot antenna in the first band, so as to fine adjust the frequency and bandwidth of the first band covered by the multi-band slot antenna.

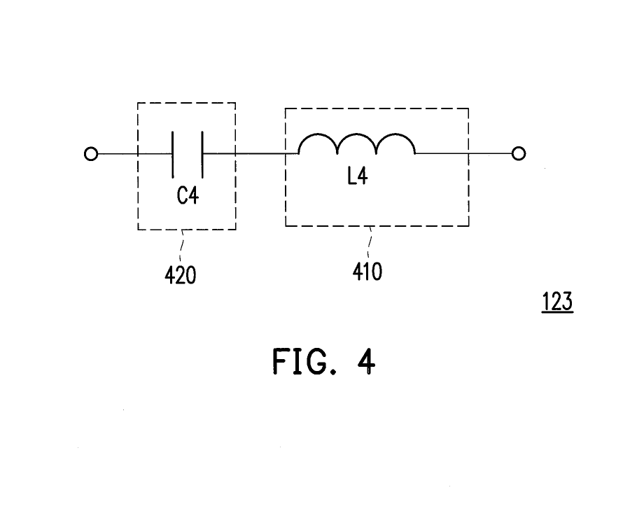

It should be mentioned that, although the embodiment depicted in FIG. 3 exemplified the implementation of the first resonant unit and the second resonant unit, the present invention is not limited thereto. For example, FIG. 4 is a circuit diagram illustrating a resonant circuit according to another embodiment of the present invention. As shown in FIG. 4, the resonant circuit 123 comprises a first resonant unit 410 and a second resonant unit 420. Besides, the first resonant unit 410 is composed of an inductor L4, and the second :resonant unit 420 is composed of a capacitor C4.

A first end of the inductor L4 is electrically connected to the first transmission line 121, and a second end of the inductor L4 is electrically connected to the second resonant unit 420. A first end of the capacitor C4 is electrically connected to the second end of the inductor L4, and a second end of the capacitor C4 is electrically connected to the second transmission line 122. Besides, the first resonant unit 410 generates resonance in the second band through the inductor L4, and therefore the multi-band slot antenna can operate in the second band. On the other hand, the capacitor C4 in the second resonant unit 420 can be configured to adjust the excitation mode of the multi-band slot antenna in the first band. It should be noted that, the inductance values of the inductors L3 and L4 are less than 20 nH, and the capacitance values of the capacitors C32 and C4 are greater than 0.1 pF in the embodiments of FIGS. 3 and 4.

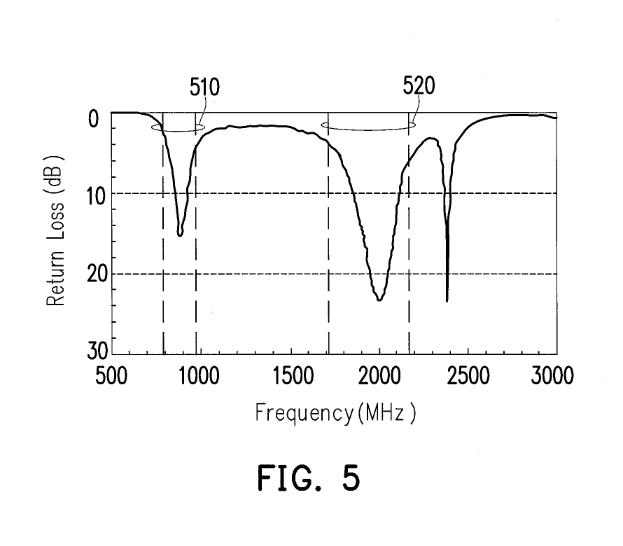

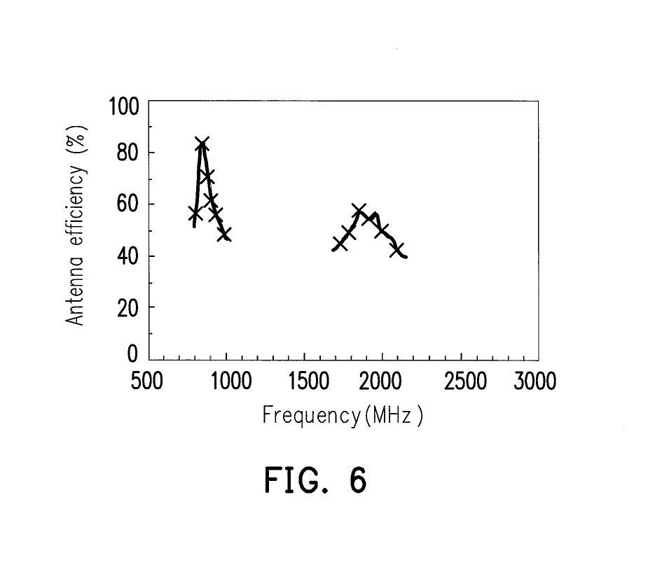

FIGS. 5 and 6 are diagrams of return loss and antenna efficiency of the multi-band slot antenna according to an embodiment of the present invention. In the embodiment of FIGS. 5 to 6, the size of the substrate 130 is about 115×60 mm² and closed to 4.7-inch Smart phone. Besides, the resonant circuit 123 in the feeding structure 120 can be implemented by using the resonant unit 310 and 320 in FIG. 3. Accordingly, as shown in FIGS. 5 and 6, the multi-band slot antenna can operate in the first band 510 and the second band 520. Furthermore, the frequency range of the first band 510 is about 791˜960 MHz, and the antenna efficiency of the multi-band slot antenna in the first band 510 is about 46%˜83%. Furthermore, the frequency range of the second band 520 is about 1,710˜2,170 MHz, and the antenna efficiency of the multi-band slot antenna in the second band 520 is about 40%˜57%. In other words, the characteristic of the multi-band slot antenna can meet the practical applications, and the operation bands of the multi-frequency slot antenna may cover LTE Band20/GSM850/900/1800/1900/WCDMA Band 1.

In view of the foregoing, one slot is disposed on the ground element and the resonant circuit is disposed in the feeding structure. Accordingly, the ground element and the feeding structure can form a multi-band slot antenna. In other words, the multi-band slot antenna only needs to employ one slot to achieve the characteristic of the multi-band operation, and that further facilitates the development of the slim-type mobile communication device.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mobile communication device comprising:
a ground element comprising a slot; and
a feeding structure, crosses the slot, and comprising:
a first transmission line and a second transmission line; and
a resonant circuit, electrically connected in series between the first transmission line and the second transmission line, wherein the resonant circuit receives a feeding signal through the first transmission line and is electrically connected to the ground element through the second transmission line.

2. The mobile communication device according to claim 1, wherein the ground element and the feeding structure form a multi-band slot antenna, the multi-band slot antenna generates an excitation mode through the slot to operate in a first band, and the resonant circuit excites the multi-band slot antenna so that the multi-band slot antenna further operates in a second band.

3. The mobile communication device according to claim 2, wherein a length of the slot is one-eighth wavelength of a lowest frequency of the first band.

4. The mobile communication device according to claim 2, wherein the resonant circuit comprises:
a first resonant unit, resonating in the second band so that the multi-band slot antenna operates in the second band; and
a second resonant unit, adjusting the excitation mode of the multi-band slot antenna in the first band.

5. The mobile communication device according to claim 4, wherein the first resonant circuit comprises:
a first capacitor, having a first end electrically connected to the first transmission line and a second end electrically connected to the ground element; and
an inductor, having a first end electrically connected to the first end of the first capacitor and a second end electrically connected to the second resonant unit.

6. The mobile communication device according to claim 5, wherein the second resonant unit comprises a second capacitor, a first end of the second capacitor is electrically connected to the second end of the inductor, and a second end of the second capacitor is electrically connected to the second transmission line.

7. The mobile communication device according to claim 4, wherein the first resonant unit comprises an inductor, a first end of the inductor is electrically connected to the first transmission line, and a second end of the inductor is electrically connected to the second resonant unit.

8. The mobile communication device according to claim 7, wherein the second resonant unit comprises a capacitor, a first end of the capacitor is electrically connected to the second end of the inductor, and a second end of the capacitor is electrically connected to the second transmission line.

9. The mobile communication device according to claim 1, wherein one of the resonant circuit, first transmission line and second transmission line is opposite to the slot.

10. The mobile communication device according to claim 1, wherein the slot penetrates the ground element and the slot has a closed end and an open end.
